(19) United States
(12) Patent Application Publication
(10) Pub. No.: US 2007/0067362 A1
(43) Pub. Date: Mar. 22, 2007

(54) Undo function for unzipped files

(75) Inventor: James M. McArdle, Austin, TX (US)

Correspondence Address: MCGRATH, GEISSLER, OLDS & RICHARDSON, PLLC, P.O. BOX 7085, ALEXANDRIA, VA, 22307, US

(73) Assignee: International Business Machines Corporation

(21) Appl. No.: 11/232,770

(22) Filed: Sep. 22, 2005

(51) Int. Cl. G06F 17/30

(52) U.S. Cl. 707/204

(57) ABSTRACT

Methods 300 and systems 100 are provided for managing files unzipped from a zipped archive file which may have been received, for example, as an email attachment. In response to an undo-unzip command from a user, a manifest associated with the archive is accessed that includes information for identifying the files previously unzipped from the archive file. The undo-unzip command causes the unzipped files to be located and deleted. If unzipped files are found which have been edited or modified since being decompressed, they may be selected to avoid deletion.

### BACKGROUND

1. Field

The present embodiments relate generally to systems and methods for managing electronic files, and more specifically to systems and methods for managing decompressed files that were transmitted or stored in a compressed data file format.

2. Background

Data files are often compressed in order to more efficiently download, transmit or store the files. Files are often compressed as “zip” files for sending in email since it takes less bandwidth to send a smaller, compressed file than to send the file in its original, uncompressed format. Stored files may also be compressed or zipped to save computer memory and storage resources, and many of the files available on the Internet are stored in a compressed file format for quicker, more efficient downloading.

Data files, and in particular, bit map files, often contain long strings of repetitive ones or zeros. Typically, compression techniques replace redundant data strings or patterns with more concise codes representing the repetitive data. There are a number of commercially available compression applications and shareware programs that allow users to combine several files into a single, compressed file called an archive. An archive is a file containing multiple files encoded and stored in a compressed format, e.g., as a ZIP file. The data compression utility programs work on virtually any type of file, and the files to be combined need not be the same file type or data format. Text files, image files, audio files, video files and the like may be combined together into one single compressed archive file for transmission or storage. The original files contained in the archive are decompressed back into their original format upon being received as an email attachment or retrieved from storage. ARC, PKzip, PKware, and Winzip are among the widely available compression utility programs that may be used to compress multiple files into an archive file.

Once the data compression program, sometimes called a data encoder, has been used to compress one or more input files into a smaller sized archive file, the same program may be used to decompress the data back into its original format. In the early implementations of data compression programs, the receiving party needed to run the same data compression utility program as the sending party in order to decompress the received data file or archive. Compressed files which required the compression utility to decompress them typically had a file extension such as “.zip”. More recently, however, self-extracting files have become prevalent. A self-extracting file, when executed, decompresses the compressed output file or files without the need to have the compression utility program available and running at the receiver end to decompress the file. A self-extracting file is an executable file which has a decompression engine attached to the compressed input file. Self-extracting compressed files or archives typically have an executable file extension such as the “.exe” extension.

Once the files are unzipped and moved into various locations on a computer's hard drive or a network, it becomes troublesome to manage the files in the event updated files are received or the user no longer wishes to retain the decompressed files.

### SUMMARY

Embodiments disclosed herein address the above stated needs by providing systems and methods for managing unzipped files from an archive. Upon receiving an undo-unzip command, a manifest associated with the archive is accessed. The manifest includes information for identifying the unzipped files. In response to the undo-unzip command, the unzipped files are deleted. In at least one embodiment the manifest includes a list of decompressed files from the archive, locations where each of the decompressed files are stored, and a checksum for each of the decompressed files. In some embodiments all the files from the archive are deleted in response to the receiving of the undo-unzip command, while in other embodiments decompressed files which have been edited of modified may be selected to avoid deletion. In some embodiments the archive may be recreated before deleting all the decompressed files. In some embodiments the archive was received as a self-executing zipped email attachment file.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIGS. 1A and 1B depict a system for implementing various embodiments of the invention;

FIG. 2 is a flowchart illustrating a method of unzipping files in accordance with various embodiments of the invention; and

FIGS. 3A and 3B depict activities in a method of undoing the unzipping of files in accordance with various embodiments of the invention.

### DETAILED DESCRIPTION

The following description of the various exemplary embodiments is illustrative in nature and is not intended to limit the invention, its application, or uses. For the purposes of this disclosure, an “archive” is a collection of two or more files that have been compressed and bundled together into one single file. An archive may be depicted in an email as a “zipped” folder icon representing an attachment to the email. An archive may contain files of the same type or different types (e.g., .txt, .rtf, .doc, .html, tiff, .pdf, .jpg, .gif, tif, .bmp, .wav, or other like file types or formats). The terms “zipped” and “compressed” are used interchangeably herein, as are the terms “unzipped” and “decompressed.” A “zipped” or “compressed” file has been encoded in a format which reduces data redundancy or otherwise reduces the size of the file. Unzipping or decompressing a file returns the file to its original size before being zipped or compressed.

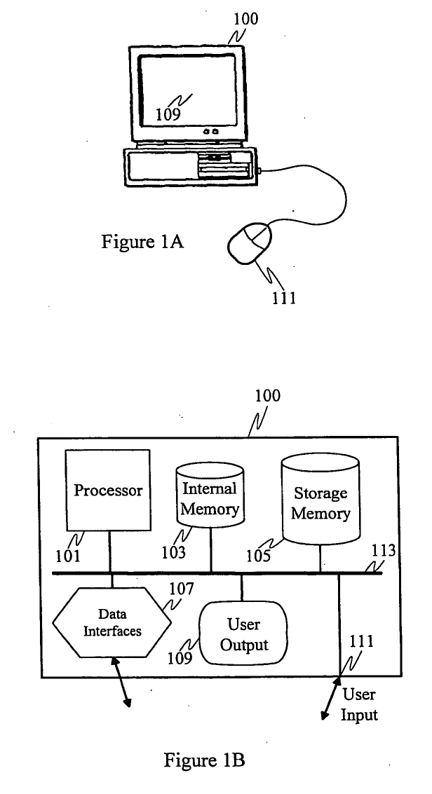

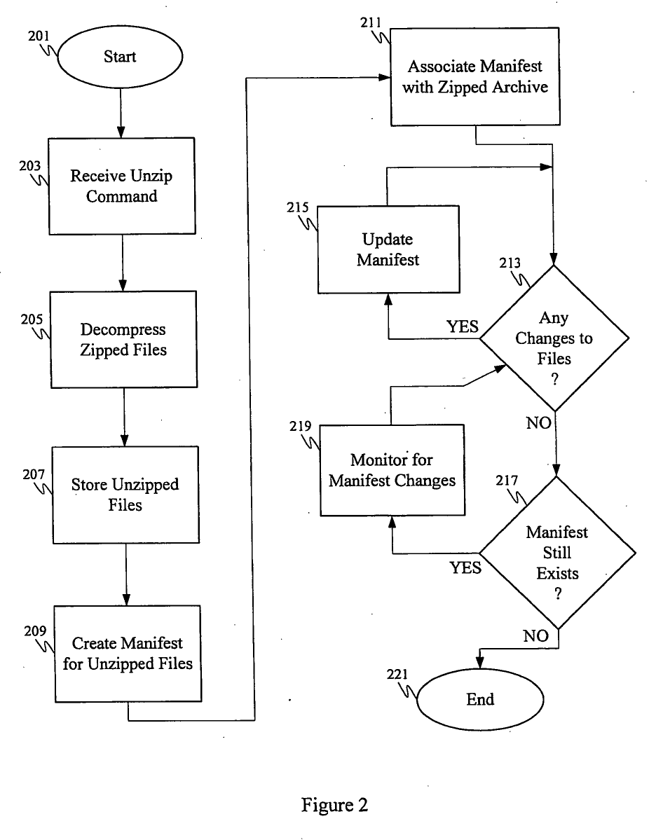

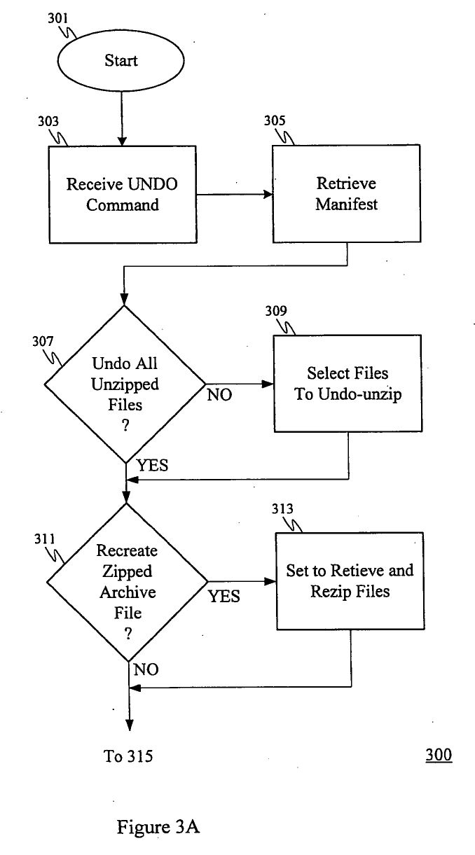

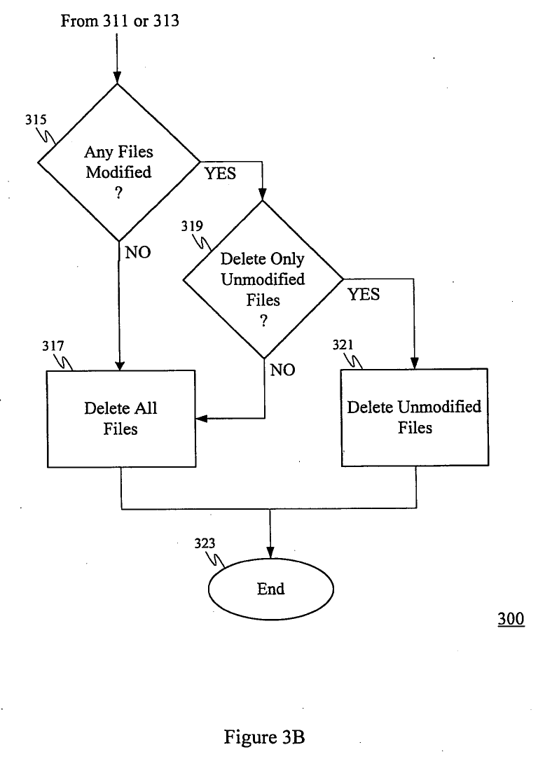

FIG. 1A depicts a computer system 100 for implementing various embodiments of the invention. FIG. 1B depicts a block diagram of the computer system 100. As shown in FIG. 1B the computer system 100 typically includes a processor 101 containing circuitry or other logic capable of performing or controlling the processes, steps and activities involved in practicing the embodiments disclosed herein. The processor 101 is generally embodied as either a microprocessor or an application specific integrated circuit (ASIC), but may be a combination of two or more distributed processors or any other circuitry or logic capable of carrying out commands or instructions such as those of a computer program. For example, in some embodiments the processor 101 may run a computer program or routine which performs one or more of the activities depicted in FIG. 2 or FIGS. 3A and 3B.

The processor 101 is configured to communicate with an internal memory 103, for example, via a bus 113 or other communication link. The memory 103 may be any of several types of storage devices used for storing computer programs, routines, or code, including the instructions and data for carrying out activities of the various embodiments such as the activities discussed herein. The memory 103 and 105 may be implemented in any form suitable for storing data in a computer system 100, for example, as random access memory (RAM), read only memory (ROM), flash memory, registers, hard disk, or removable media such as a magnetic or optical disk, or other storage medium known in the art. The memory 103 and 105 may comprise a combination of one or more storage devices or technologies.

The computer system 100 also includes one or more input/output (I/O) units such as user output 109 and user input 111. The user output 109 is often implemented as a monitor in the form of a cathode ray tube (CRT) or a liquid crystal display (LCD) screen. The user output 109 typically includes one or more audio speakers as well as a video monitor. The computer system 100 typically includes one or more user input devices 111. The user input devices 111 may include a keyboard, a tablet surface and pen, a mouse, a microphone and speech recognition routine, and/or other like types of input/output devices. The user output 109 and user input 111 may include other devices known to those of ordinary skill in the art and suitable for use with a computer system 100. Quite often the computer system 100 is configured to include data interface unit 107 for connecting to networks such as the Internet, to a local area network (LAN) or a wide area network (WAN), to the Public Switched Telephone System (PSTN) or to a wireless telephone network. The data interface unit 107 may include a wired and/or wireless transmitter and receiver. Although the bus 113 is depicted as a single bus connecting all of the component parts of the system, the computer system 100 may include two or more separate buses each connected to a subset of the system components.

The computer system 100 is configured to run a data compression application program which can compress and decompress data files. The data compression application program may be a Windows™ based program or other graphical user interface (GUI) based program, since the majority of computers today operate using GUI based operating systems such as one of the Microsoft Windows™ products. When a multi-file archive is unzipped using a GUI-based compression utility, a new window is typically opened listing the decompressed files or representing them as icons. The user may then drag the icons to another folder, or open the various files and save them to locations where the files are needed. The data compression application program may use any of several available data compression techniques for compressing the data files.

The major categories of data compression techniques include statistical compression methods, mathematical transform compression, dictionary encoding and run length encoding. In run length encoding (RLE) data compression, the strings of consecutive symbols are replaced with a shorthand code that indicates the symbol being replaced and the number of consecutive occurrences in the string. In statistical compression, symbols or strings of symbols are replaced by codes based on the frequency of occurrence of the repetitive strings. Since some replacement codes are shorter than other replacement codes, the shortest codes are used to replace the symbols or strings which tend to occur most frequently. In dictionary encoding, as data is encoded for storage or transmission, a set of codes is developed for use in compressing the data, with the dictionary being created as the data is encoded. Then, as the data is received, or retrieved from storage, the dictionary of compression codes is reconstructed. Alternatively, the dictionary of encoding definitions may be predefined before the data encoding begins. Data compression using transform techniques involves the performance of a mathematical transformation on the source data into a more concise format.

Although FIGS. 1A and 1B depict a computer system 100 for practicing various embodiments, the invention may also be practiced using other devices. For example, the various embodiments may be implemented on a cellular or wireless telephone, a personal digital assistant (PDA), a pager, a wireless navigation unit, an audio or video content download unit, a wireless gaming device, an inventory tracking unit, a dedicated device for word processing, text editing, computer aided design (CAD) or computer aided manufacturing (CAM), or any other like types of devices used for communicating, storing or processing information.

FIG. 2 is a flowchart illustrating a method of unzipping files in accordance with various embodiments of the invention. The method begins at block 201, and progresses to 203 where the system receives an unzip command. Generally, the unzip command comes from a user. For example, a user may double click on a zipped file icon representing a file attached to an email, or the user may select an icon or menu item in a compression utility program, or the user may input a certain combination of keystrokes to initiate the unzip command. The unzip command may be in the form of any input devised for a user to control a computer (e.g., speech recognition, touch pad entry, or the like). In some embodiments the unzip command may not come from a user, but may instead come from another computer or other logic which is accessing a stored or received file or zipped archive. The system receiving the unzip command input may be a computer system 100 as shown in FIG. 1, or other information processing device or logic capable of processing or managing zipped files.

In response to receiving the unzip command in 203, the system unzips the selected archive in 205. If the archive is password protected, block 205 may entail the entering of a password at some point, typically before the files can be used or saved in uncompressed form. As part of 205, the files contained in the archive are often displayed for the user, for example, in a new window opened upon receiving the unzip command. Once the files of the archive are displayed in 205, the method proceeds to 207 where the user may choose to store one or more of the newly decompressed files of the archive.

In 207 of FIG. 2 the user may open or otherwise operate any of the decompressed files from the archive. Instead of opening a file, the user may opt to drag the icon representing the file to a different folder for storage or for later use. In some implementations, either the user's compression utility program or the decompression engine attached to a self-executable compressed input file, may be configured to store the decompressed files to a default folder upon being decompressed. The user may then access the files in the default folder and either operate the files from that folder or move them to a different location for storage or use.

Upon completing 207 (or as block 207 is being performed) a manifest is created in 209 containing information of the decompressed files. The information in the manifest is used to keep track of the identity and location of the decompressed files, and in some embodiments, whether the decompressed files have been edited after being unzipped. The information may include the filename and directory or other location where the file is saved, the file size, the date and time that the file was saved, a checksum for the file, and other like types of information about the decompressed files and the archive. In some embodiments a thumbnail of the file or other sample data may be kept in the manifest.

Once the manifest has been created in 209 the method proceeds to 211 and the manifest is associated with the zipped file, or otherwise identified with the zipped file. In this way, if the zipped file is later accessed the data in the manifest may be used to identify the files previously decompressed from the zipped archive, and indicate the location where the files were saved. In 211 the manifest may be associated with the zipped file in any of several different manners. The manifest may be saved as part of the zipped file, and then be accessed by again opening the zipped file. The manifest may be separate from the zipped archive file, with the zipped file containing a pointer or other indication of where the manifest is saved. In yet other embodiments, the manifest and zipped archive file may both be accessed from a compression utility program. For example, the compression utility program may contain a list of zipped archives with each zipped archive entry having an associated manifest of information about its compressed files. By associating the manifest with the zipped archive file, the manifest and its information may be accessed either by accessing the zipped archive file itself or by referencing the zipped archive file as the file for which a manifest is desired. Upon completion of 211 the method proceeds to 213.

In 213 it is determined whether there have been any changes to the decompressed files that would warrant updating the information in the manifest. Such changes may entail, for example, whether any of the decompressed files was moved, edited or deleted by a user. If, in 213, it is determined that the information about the decompressed files has changed, the method proceeds from 213 along the “YES” branch to 215. Block 215 allows the manifest to be updated. This is useful in those instances when a user unzips an archive containing a number of files, but does not initially save all of the decompressed files. In such instances, data is kept in the manifest for the files which are saved by the user. An indication may also be kept in the manifest of those decompressed files which were not saved by the user (e.g., “unzipped version of file ‘filename.txt’ not yet saved to a directory”). After a manifest has been created, if the user later accesses the zipped archive again and saves any of the previously unsaved files, the manifest may be updated in 215 to reflect the changed status of the file(s). In some embodiments, if a file is unzipped and stored, and then edited or moved to a new location, the manifest may subsequently be updated to reflect that the file was edited or moved. After the manifest has been updated the method proceeds from 215 back to 213.

If, in 213, it is determined that no changes have been made to the files that would warrant updating the manifest, the method proceeds to 217 along the “YES” branch. In 217 it is determined whether the manifest still exists, or whether there is any need to continue storing information in the manifest for an undo-unzip command. If the manifest does still exist, the method proceeds to 219 along the “YES” path. In 219 the decompressed files are monitored for any changes that should be reflected in the manifest. From 219 the method loops back to 213 again. Back in 217, if the manifest no longer exists the method proceeds to 221 and ends.

FIG. 3 is a flowchart for a method of undoing the unzipping of files in accordance with various embodiments of the invention. The method begins in 301 and progresses to 303 where an “undo-unzip” command is received. The undo-unzip command may be in any of a number of forms so long as the command achieves the intended purpose. The purpose of the undo-unzip command is to undo or reverse at least some of the effect of unzipping an archive file without affecting other files unrelated to the archive file which may have been processed by the computer during the time the unzipped files of the archive were stored on the computer. The undo-unzip command results in deleting at least some of the un-edited files that were decompressed when the archive file was unzipped. The actual word or term used for the “undo-unzip” command is of little significance, so long as the command itself does not conflict with any other commands or instructions. The undo-unzip command may be called a “reverse-unzip” command, an “unzip-annul” command, an “unzip go-back” command or any other like term or word. The undo-unzip command may be implemented as a combination of keystrokes pressed by a user, either in any context or in a particular context such as during the operation of the compression utility program. The undo-unzip command may be received as any input devised for a user to control a computer or other processing device, including for example, speech recognition, touch pad entry, mouse clicks, key stroke combinations, or the like.

The undo-unzip command is typically received by a computer from a user. The system receiving the undo-unzip command may be a computer system 100 as shown in FIG. 1. However, the undo-unzip command may be received by other types of devices aside from computers. The undo-unzip command may be received by any device used for communicating, storing or processing information, and in particular, information in the form of files from an unzipped archive. In some embodiments the undo-unzip command may not come from a human user (or directly from a human user), but may instead come from another computer or other processing device. For the sake of illustration, FIG. 3 will be explained in terms of a human user providing an undo-unzip command to a computer, although, as discussed above, many other implementations are disclosed or are easily derived from the description of the various embodiments.

Once the computer has received the undo-unzip command in 303 the method proceeds to 305. In 305 the manifest associated with the archive is retrieved or otherwise accessed. The manifest contains information about the unzipped files used to keep track of their identity and location, and in some embodiments, the manifest contains information concerning whether the unzipped files have been edited after being unzipped from the archive. The information in the manifest typically includes the filename and directory or other location where the unzipped files are saved, the files sizes, the dates and times that the files were saved, and a checksum for the files. The manifest may also contain similar information for the archive, if it was not deleted after its files were unzipped. Depending upon the security considerations, the manifest may also contain passwords assigned to the various files so that all the unzipped files may be conveniently processed without having to enter a password for each file individually. It is useful to have a central repository of passwords within the manifest, especially when the archive contains dozens or even hundreds of files. However, if an accumulation of passwords (even encrypted passwords) is determined to create a security threat, then a user may be prompted to individually enter passwords rather than storing them in the manifest.

Once the manifest has been retrieved in 305, the method proceeds to 307 where it is determined whether or not to unzip all files in the archive. In some embodiments the unzip command may unzip all decompressed files from an archive, while in other embodiments a subset of the files may be selected to be undone. If all files are to be undone the method proceeds along the “YES” path to 311. If, in 307, it is determined that fewer than all of the decompressed files of the archive are to be undone, then the method proceeds along the “NO” path to 309. In 309 the files to be undone are selected. The selection may be done by the users, for example, by highlighting the names of the files to be undone from a listing in the manifest. Or the selection may be done on the basis of one or more criteria. For example, the files decompressed on a certain date may be selected for the undo-unzip command, or files of only a certain type may be undone (e.g., only tif files or only .exe files, etc.). Once the files to be subjected to the undo-unzip command are selected in 309 the method proceeds to 311.

In 311 it is determined whether a zipped archive file is to be created as a result of the undo-unzip process. In some embodiments, the zipped archive may have been deleted by the user upon, or after, being unzipped. In 311 the user is provided with the option to recreate the zipped archive file as the undo-unzip command is performed. This is useful, for example, when a user receives and unzips a zipped archive file in an email, processes the files or views (or listens) to them, and then wants to forward the file on to another destination. By creating (or recreating) a zipped archive file as the decompressed files are being undone, the user is able to conveniently and efficiently forward the archive to another user. If, in 311, it is determined that an archive is to be created, the method proceeds to 313 to set up the process for creating an archive file. In 313 it is determined where the archive is to be saved, if at all, and the logic for gathering and compressing the decompressed files is set. Once 313 is completed, or if it is determined in 311 that no archive is to be created, the method proceeds to 315 of FIG. 3B.

In 315 it is determined whether any of the decompressed files from the archive have been modified since being unzipped. If no files have been modified the method proceeds from 315 to 317 in accordance with the “NO” branch. If, in 315, it is determined that one or more of the decompressed files from the archive have been modified since being unzipped, the method proceeds from 315 along the “YES” branch to 319 to ascertain how to handle the modified files. In 319 it is determined whether only the unmodified files are to be deleted, or whether any files which were modified since being unzipped from the archive are to be deleted as well. If all files are to be deleted the method proceeds from 319 along the “NO” branch to 317. In 317 the decompressed files, the location of which is provided by the manifest, are deleted from the computer system 100 where they were saved upon being unzipped from the archive. If a zipped archive is to be created, in accordance with 311, then the decompressed files are compressed for the purpose of creating the archive file before being deleted in 317.

If, back in 319, it is determined that only unmodified files are to be deleted, the method proceeds from 319 along the “YES” branch to 321. In 321 the unmodified files are detected and deleted. Whether a file has, or has not, been modified may be detected based on the checksum of the file contained in the manifest, or possibly based on the date and time the file was last saved or last modified. Alternatively, if the archive is still available, the file in original form from the archive may be compared to the decompressed file saved on computer system 100 to determine whether the file has been modified in any way. Once the files have been deleted from computer system 100 in either 317 or in 321 the method proceeds to 323 and ends.

Various steps may be included or excluded as described above, or performed in a different order, with the rest of the activities still remaining within the scope of at least one exemplary embodiment. For example, in at least one exemplary embodiment, if the default process is to apply the undo-unzip command to all unzipped files, then blocks 307 and 309 may be omitted and the method can proceed directly from 305 to 311. Other deviations from the order depicted in the figures may fall within the scope of this disclosure, and some activities may be performed in an order other than that shown in the figures. For example, blocks 311 and 313 may be performed at the end of the process before block 323 by temporarily saving the decompressed files to be deleted and then providing a prompt displayed to the user asking whether or not a zipped archive is to be recreated.

The processing units, processors and controllers described herein (e.g., processor 101 of FIG. 1B) may be of any type capable of performing the stated functions and activities. For example, a processor may be embodied as a microprocessor, microcontroller, DSP, RISC processor, or any other type of processor that one of ordinary skill would recognize as being capable of performing the functions described herein. A processing unit in accordance with at least one exemplary embodiment can operate computer software programs stored (embodied) on computer-readable medium, e.g. hard disk, CD, flash memory, ram, or other computer readable medium as recognized by one of ordinary skill in the art. The computer software programs can aid or perform the steps and activities described above. For example computer programs in accordance with at least one exemplary embodiment may include: source code for receiving an undo-unzip command, source code for accessing a manifest associated with the archive, source code for identifying the unzipped files based on information in the manifest, source code for deleting the unzipped files in response to the receiving of the undo-unzip command, and source code for creating the manifest prior to the receiving of the undo-unzip command and in response to receiving an unzip command. There are many further source codes that may be written to perform the stated steps and procedures above, and these are intended to lie within the scope of exemplary embodiments.

The use of the word “exemplary” in this disclosure is intended to mean that the embodiment or element so described serves as an example, instance, or illustration, and is not necessarily to be construed as preferred or advantageous over other embodiments or elements. The description of the invention provided herein is merely exemplary in nature, and thus, variations that do not depart from the gist of the invention are intended to be within the scope of the embodiments of the present invention. Such variations are not to be regarded as a departure from the spirit and scope of the present invention.

What is claimed is:

1. A method of managing unzipped files from an archive, the method comprising:
receiving an undo-unzip command;
accessing a manifest associated with the archive;
identifying the unzipped files based on information in the manifest; and
deleting the unzipped files in response to the receiving of the undo-unzip command.

2. The method of claim 1, further comprising:
creating the manifest prior to the receiving of the undo-unzip command and in response to receiving an unzip command.

3. The method of claim 2, wherein the manifest comprises a list of decompressed files from the archive, locations where each of the decompressed files are stored, and a checksum for each of the decompressed files.

4. The method of claim 1, wherein all files from the archive are deleted in response to the receiving of the undo-unzip command.

5. The method of claim 2, wherein the archive is a first archive, the method further comprising:
deleting the first archive file in response to receiving the unzip command; and
creating a second archive file in response to the receiving of the undo-unzip command;
wherein the second archive file comprises zipped versions of the unzipped files from the first archive.

6. The method of claim 1:
wherein the unzipped files are unmodified files from the archive; and
wherein modified files from the archive are not deleted.

7. The method of claim 1, wherein the archive was received as a self-executing zipped email attachment file.

8. The method of claim 1:
wherein the unzipped files are stored in a memory which also stores a plurality of other files; and
wherein said undo-unzip command does not affect said plurality of other files.

9. An archive management system comprising:
a user input device configured to receive an undo-unzip command;
a memory suitable for storing unzipped files and a manifest associated with an archive; and
a processor configured to identify the unzipped files based on information in the manifest and control the memory to delete the unzipped files in response to the undo-unzip command.

10. The system of claim 9, further comprising:
a data interface configured to receive an email communication via a network;
wherein the archive is received by the system in the email communication via the network.

11. The system of claim 9, wherein the manifest comprises a list of decompressed files from the archive, locations where each of the decompressed files are stored, and a checksum for each of the decompressed files.

12. A computer readable media embodying a method of managing unzipped files from an archive, the method comprising:
receiving an undo-unzip command;
accessing a manifest associated with the archive;
identifying the unzipped files based on information in the manifest; and
deleting the unzipped files in response to the receiving of the undo-unzip command.

13. The computer readable media of claim 12, further comprising:
creating the manifest prior to the receiving of the undo-unzip command and in response to receiving an unzip command.

14. The computer readable media of claim 13, wherein the manifest comprises a list of decompressed files from the archive, locations where each of the decompressed files are stored, and a checksum for each of the decompressed files.

15. The computer readable media of claim 12, wherein all files from the archive are deleted in response to the receiving of the undo-unzip command.

16. The computer readable media of claim 13, wherein the archive is a first archive, the method further comprising:
deleting the first archive file in response to receiving the unzip command; and
creating a second archive file in response to the receiving of the undo-unzip command;
wherein the second archive file comprises zipped versions of the unzipped files from the first archive.

17. The computer readable media of claim 12:
wherein the unzipped files are unmodified files from the archive; and
wherein modified files from the archive are not deleted.

18. The computer readable media of claim 12, wherein the archive was received as a self-executing zipped email attachment file.

19. The computer readable media of claim 12:
wherein the unzipped files are stored in a memory which also stores a plurality of other files; and
wherein said undo-unzip command does not affect said plurality of other files.
